(19) United States
(12) Patent Application Publication
(10) Pub. No.: US 2014/0049967 A1
(43) Pub. Date: Feb. 20, 2014

(54) LIGHT BEAM ADJUSTING STRUCTURE FOR LIGHT EMITTING DIODE (LED) LAMP

(71) Applicant: Nanqing Zhou, Xiamen City (CN)

(72) Inventor: Nanqing Zhou, Xiamen City (CN)

(21) Appl. No.: 13/695,679

(22) PCT Filed: Jun. 28, 2011
(86) PCT No.: PCT/CN11/76458

§ 371 Date: Nov. 1, 2012

(30) Foreign Application Priority Data
Apr. 13, 2011 (CN) 201120107421.6

(51) Int. Cl. F21V 14/06

(52) U.S. Cl. CPC F21V 14/06
USPC 362/287

(57) ABSTRACT

A light beam adjusting structure for a Light Emitting Diode (LED) lamp includes a rotary sleeve and a lens fixing base which are mounted in a containing trough of a housing of the LED lamp. The rotary sleeve has at least one longitudinal slot and an annular boss. The lens fixing base includes a lens mounted at a front end thereof and a protrusion corresponding to the longitudinal slot. An LED chip is mounted at the bottom of the containing trough. The side wall of the containing trough has an engaging groove and at least one spiral groove. The engaging groove is close to the bottom of the containing trough. By adopting the above-mentioned solution, a user only needs to turn the rotary sleeve and thus can control the longitudinal movement of the lens to focus, whose operation is convenient and saves labors.

### BACKGROUND OF THE INVENTION

1. Field of the Invention

The present invention relates to an LED lamp, and more particularly to a light beam adjusting structure for a Light Emitting Diode (LED) lamp.

2. Description of the Prior Art

A conventional LED lamp capable of adjusting the brightness and the range of the light beam comprises a convex lens in front of an LED. The distance between the convex lens and the LED is adjusted through an adjustment structure to adjust the focus and to adjust the light beam.

The adjustment structure adopts a damping friction way for adjustment. The configuration is simple, but the operation is more laborious. The use of the adjustment structure is limited. Accordingly, the inventor of the present invention has devoted himself based on his many years of practical experiences to solve these problems.

### SUMMARY OF THE INVENTION

The primary object of the present invention is to provide a light beam adjusting structure for a Light Emitting Diode (LED) lamp for simply and labor-saving operation.

In order to achieve the aforesaid object, the light beam adjusting structure for a Light Emitting Diode (LED) lamp comprises a rotary sleeve and a lens fixing base. The rotary sleeve and the lens fixing base are mounted in a containing trough of a housing at a front end of the LED lamp. The rotary sleeve is a cylinder-shaped body, and has at least one longitudinal slot formed on a side wall thereof and an annular boss at a bottom thereof. The lens fixing base is a cylinder-shaped body. A lens is mounted at a front end of the lens fixing base. The lens fixing base has a protrusion on an outer wall thereof corresponding in position to the longitudinal slot of the rotary sleeve. An LED chip is mounted at the bottom of the containing trough of the housing. The housing has an engaging groove on a side wall of the containing trough to mate with the annular boss of the rotary sleeve and at least one spiral groove to mate with the protrusion of the lens fixing lens. The engaging groove is disposed close to the bottom of the containing trough.

Preferably, the lens has a flange, and the lens fixing base has a recess at a front end thereof for connection of the lens.

Preferably, the rotary sleeve has a notch which is disposed under the longitudinal slot and has a width less than that of the longitudinal slot.

When in use, the user just turns the rotary sleeve to bring the protrusion of the lens fixing base to move up or down along the spiral groove, such that the lens is moved up or down so as to adjust the distance between the lens and the LED chip to achieve focusing. The operation is simple and labor-saving.

### BRIEF DESCRIPTION OF THE DRAWINGS

FIG. 1 is an exploded view of the present invention;

FIG. 2 is a sectional view showing the housing of the present invention;

FIG. 3 is a sectional view of the present invention; and

FIG. 4 is another sectional view of the present invention in an operating state.

### DETAILED DESCRIPTION OF THE PREFERRED EMBODIMENTS

Embodiments of the present invention will now be described, by way of example only, with reference to the accompanying drawings.

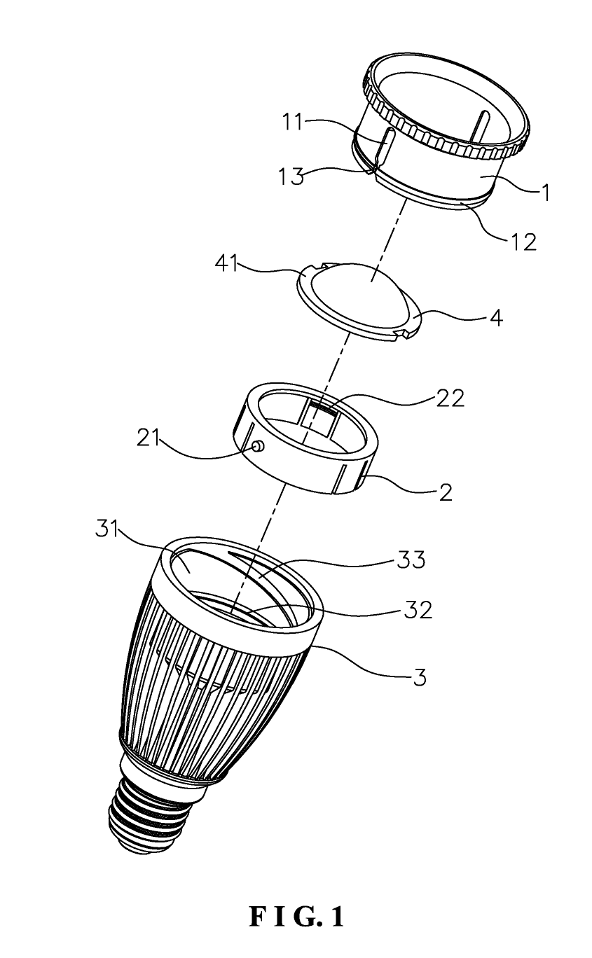

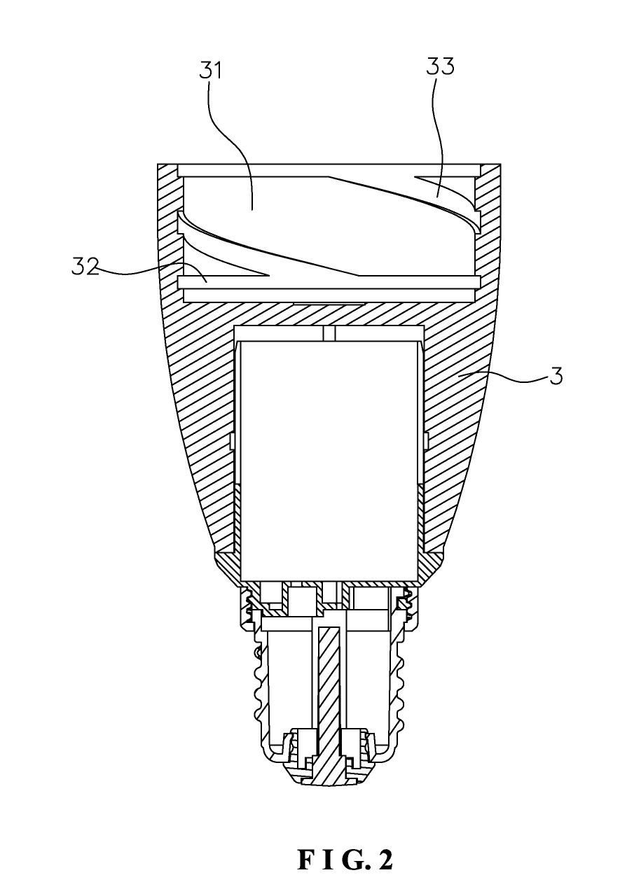

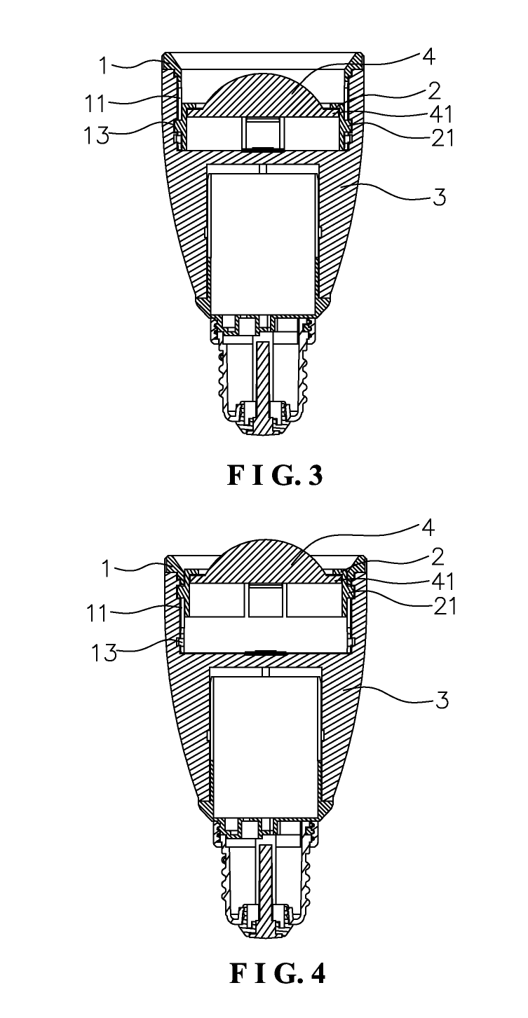

As shown in FIG. 1 to FIG. 3, a light beam adjusting structure for a Light Emitting Diode (LED) lamp according to a preferred embodiment of the present invention comprises a rotary sleeve 1 and a lens fixing base 2. Both the rotary sleeve 1 and the lens fixing base 2 are mounted in a containing trough 31 of a housing 3 at a front end of the LED lamp.

The rotary sleeve 1 is a cylinder-shaped body, and has at least one longitudinal slot 11 formed on a side wall thereof and an annular boss 12 at a bottom thereof.

The lens fixing base 2 is also a cylinder-shaped body. A lens 4 is mounted at a front end of the lens fixing base 2. The lens fixing base 2 has a protrusion 21 on an outer wall thereof, corresponding in position to the longitudinal slot 11 of the rotary sleeve 1. The lens 4 is fixed to the lens fixing base 2 through different means, such as adhesive or screws. As shown in the drawings of this embodiment, the lens 4 has a flange 41. The lens fixing base 2 has a recess 22 at a front end thereof for connection of the lens 4.

An LED chip 5 is mounted at the bottom of the containing trough 31 of the housing 3. The housing 3 has an engaging groove 32 and at least one spiral groove 33 on a side wall of the containing trough 31. The engaging groove 32 is disposed close to the bottom of the containing trough 31.

To assemble the present invention, the flange 41 of the lens 4 is engaged in the recess 22 of the lens fixing base 2, and then the lens fixing base 2 is mounted in the rotary sleeve 1. The protrusion 21 is inserted in the longitudinal slot 11. After that, the rotary sleeve 1 with the lens 4 and the lens fixing base 2 is placed in the containing trough 31 of the housing 3. The protrusion 21 is located at the inlet of the spiral groove 33. The annular boss 12 of the rotary sleeve 1 is engaged in the engaging groove 32 of the side wall of the containing trough 31 to complete the assembly.

To operate the present invention, the rotary sleeve 1 is turned to bring the protrusion 21 of the lens fixing base 2 to move up or down along the spiral groove 33, such that the lens 4 is moved up or down to adjust the distance between the lens 4 and the LED chip 5 so as to achieve focusing.

The rotary sleeve 1 has a notch 13 which is disposed under the longitudinal slot 11 and has a width less than that of the longitudinal slot 11. The notch 13 is adapted for convenient insertion of the protrusion 21 of the lens fixing base 2. The side wall of the rotary sleeve 1 is resilient for the annular boss 12 to be engaged in the engaging groove 32 of the containing trough 31 conveniently.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A light beam adjusting structure for a Light Emitting Diode (LED) lamp comprising a rotary sleeve and a lens fixing base, the rotary sleeve and the lens fixing base being mounted in a containing trough of a housing at a front end of the LED lamp; the rotary sleeve being a cylinder-shaped body and having at least one longitudinal slot formed on a side wall thereof and an annular boss at a bottom thereof; the lens fixing base being a cylinder-shaped body, a lens mounted at a front end of the lens fixing base, the lens fixing base having a protrusion on an outer wall thereof corresponding in position to the longitudinal slot of the rotary sleeve; an LED chip mounted at a bottom of the containing trough of the housing, the housing having an engaging groove on a side wall of the containing trough to mate with the annular boss of the rotary sleeve and at least one spiral groove to mate with the protrusion of the lens fixing lens, the engaging groove being disposed close to the bottom of the containing trough.

2. The light beam adjusting structure for a Light Emitting Diode (LED) lamp as claimed in claim 1, wherein the lens has a flange and the lens fixing base has a recess at a front end thereof for connection of the lens.

3. The light beam adjusting structure for a Light Emitting Diode (LED) lamp as claimed in claim 1, wherein the rotary sleeve has a notch which is disposed under the longitudinal slot and has a width less than that of the longitudinal slot.
